(19) United States
(12) Patent Application Publication
(10) Pub. No.: US 2001/0017478 A1
(43) Pub. Date: Aug. 30, 2001

(54) Motor vehicle roof structure with side members which can be transferred into a stowage space

(76) Inventor: Burkhard Reinsch, Kaufbeuren (DE)

Correspondence Address: NIXON PEABODY, LLP, 8180 GREENSBORO DRIVE, SUITE 800, MCLEAN, VA, 22102, US

(21) Appl. No.: 09/761,642

(22) Filed: Jan. 18, 2001

(30) Foreign Application Priority Data
Jan. 18, 2000 (DE) 100 01 941.2

(51) Int. Cl. B60J 7/00

(52) U.S. Cl. 296/216.08

(57) ABSTRACT

A motor vehicle roof structure with a folding roof or a sliding roof which is movably guided in the area of the side members (14 and 15) between the A column (11) and the B column (12) of a motor vehicle and into a position behind them. It is provided that the side members (14 and 15) are detachably connected to the A column (11) and the B column (12), and that there is a mechanism (24, 25) for transferring the released side members (14 and 15) into a stowage space (23) in the area of a rear window shelf of the motor vehicle.

### BACKGROUND OF THE INVENTION

1. Field of the Invention

The invention relates to a motor vehicle roof structure with a folding roof or a sliding roof which is movably guided in the area of the side members between the A column and the B column of a motor vehicle and in a position behind them.

2. Description of Related Art

Vehicles of the initially mentioned type (see German Patent DE 196 36 683 C 1) offer the luxury of a roof which can be opened over a large area. This motor vehicle roof structure differs from a convertible structure essentially in that the side members and possibly the C columns border the roof opening. In addition, converting a conventional motor vehicle with a closed roof into one with a completely removable roof, i.e., into a convertible, is known (see published German Patent Application DE 37 32 581 A 1) by the entire roof together with the side members and the C columns being completely removable. However, the disadvantage here is that this roof cannot be carried along, but must, for example, be stored in a garage. An associated disadvantage is that when rainy weather begins it is not possible to quickly change back into a closed vehicle.

### SUMMARY OF THE INVENTION

In view of the foregoing, an object of this invention is to devise a motor vehicle roof structure with an enlarged roof opening which also ensures prompt changing back into the closed state.

This object is achieved by the side members being detachably connected to the A column and the B column, and a transfer mechanism being provided for transferring the released side members into a stowage space in the area of the rear window shelf of the motor vehicle.

The transfer mechanism provided, in accordance with the invention, allows the side members released from the A column or the B column to be easily deposited in a stowage space in the area of the rear window shelf of the motor vehicle. This measure also allows the motor vehicle with the inventive roof structure to be elegantly converted into a convertible, and optionally, also changed back quickly again into a vehicle with a closed roof in order, for example, to be able to effectively counter sudden rain.

The invention calls for two advantageous developments of the transfer mechanism, one in the form of kinematics of a rod assembly and one in the form of a sliding and pivoting mechanism.

In the case of the kinematics of a rod assembly, the assembly is preferably coupled in the rear area of the C column of the motor vehicle and is connected to the B column end of the side member in order to lift or lower it out of its position between the A column and the B column in order to swing it to the rear and to turn it into a transverse position for deposition in the stowage space. This sequence of lifting and pivoting motion can of course also take place in the reverse sequence, and for example, can also comprise laterally lifting of the side member out of its position between the A column and the B column, i.e., the lifting or lowering or lateral displacement of the side member from its position between the A column and the B column can generally be called a removal process.

In the case of the transfer mechanism designed alternatively as a sliding and pivoting means, it preferably comprises one guide rail per side member which runs along the C column of the motor vehicle for sliding the released side member, and a pivoting means on the back end of the guide rail in order to be able to pivot the side member into a transverse orientation for deposition in the stowage space. The guide rail is thus preferably displaced laterally inward from the C column, such that the side member is first pushed into a position in extension of the guide rail before it is transferred along the latter into the pivot position. While the side member can basically be pivoted out of the guide rail into the stowage space, it is advantageously provided that the guide rail is pivotally-mounted on the back end so that, together with the side member accommodated by it, it can be swung into the stowage space.

While, basically, the side members can be transferred manually by means of the transfer mechanism according to the invention, for the sake of greater ease, advantageously, an electric motor drive is provided for the transfer mechanism.

While the transfer of the side members into their stowage space position is explained above, the transfer mechanism is of course also designed to return the side members to their position between the A column and the B column.

Furthermore, it is advantageously provided for the detachable side members to be connected by means of lock mechanisms to the A column and the B column so that these side members, which represent structural elements of the motor vehicle roof, are incorporated into the roof support function.

The lock mechanisms advantageously comprise at least one lock tongue per end of the side members and a lock slot which accommodates it. Furthermore, advantageously an electric motor actuator is provided for the lock mechanisms. This actuator is preferably located entirely in the side member, and according to one especially advantageous development of the invention, a single electric motor serves for actuating the lock mechanisms on both ends of the side member.

In the following, the invention is explained in greater detail with reference to the accompanying drawings which show a preferred embodiment of the invention.

### BRIEF DESCRIPTION OF THE INVENTION

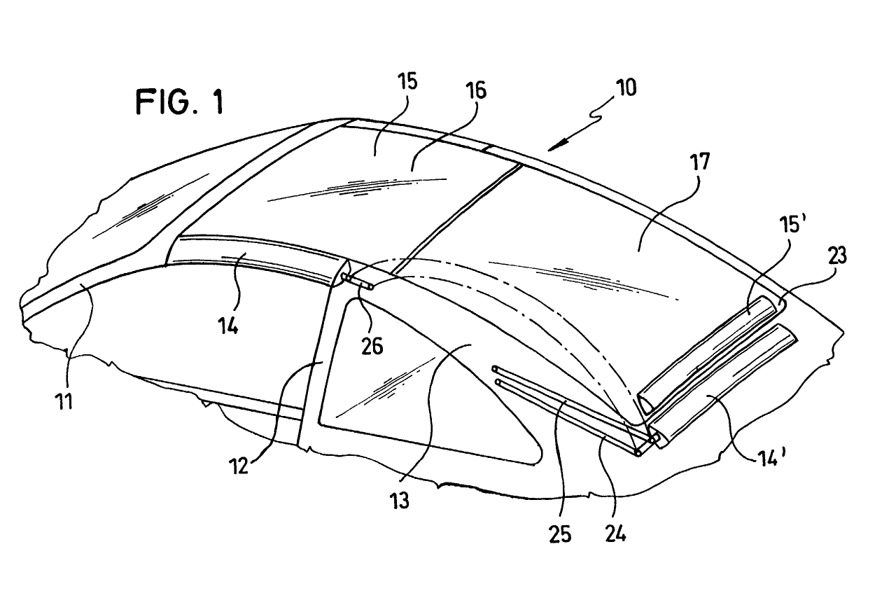

FIG. 1 is a perspective view of one embodiment of the motor vehicle roof in accordance with the invention with a simultaneous representation of the side members in both their normal position and in their stowed position;

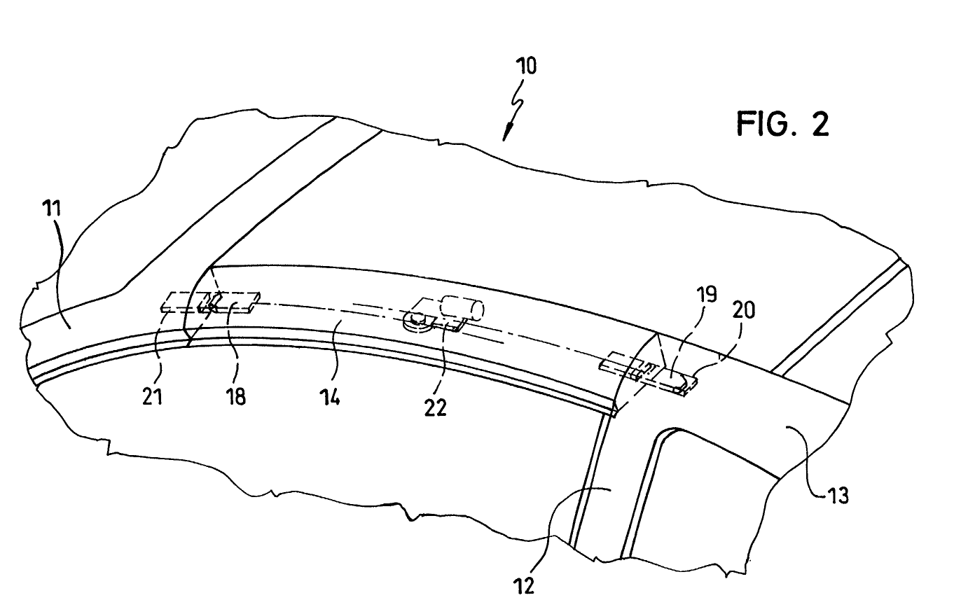

FIG. 2 is a perspective view of the motor vehicle roof structure from FIG. 1 for the left side member which is located in its position between the A column and the B column and is locked to them;

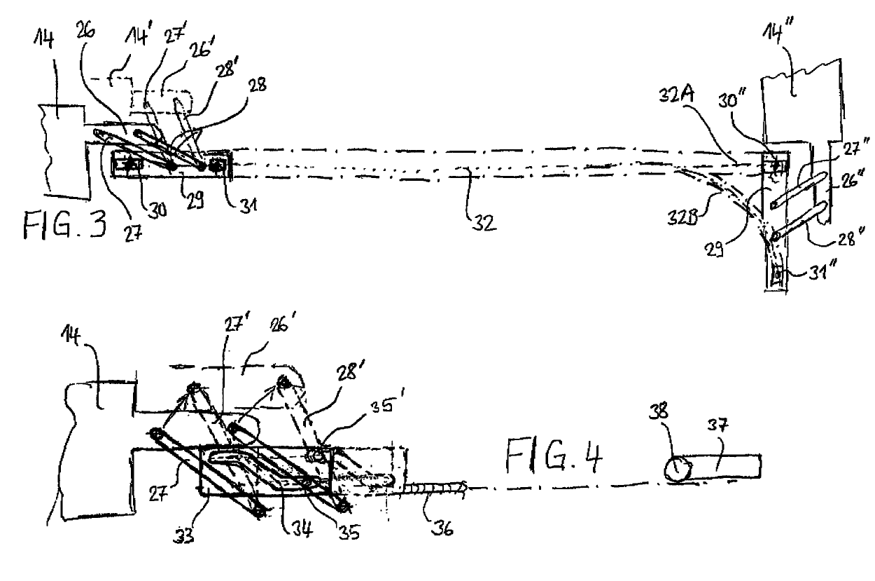

FIG. 3 shows in schematic form an alternative embodiment of the motor vehicle roof as claimed in the invention with a simultaneous representation of the side members in their normal position and in their stowed position; and

FIG. 4 shows in schematic form an actuating device for the alternative embodiment according to FIG. 3.

### DETAILED DESCRIPTION OF THE INVENTION

In FIGS. 1 & 2, the motor vehicle roof structure 10 comprises an A column 11, a B column 12 and a C column 13, a left side member 14 and a right side member 15 between the A column 11 and the B column 12, reference to left and right being in relation to the forward direction of travel or forward along the lengthwise axis of the motor vehicle. The roof structure 10 also comprises a front cover 16 and a rear cover 17, front and rear, in turn, being with reference to the forward direction of travel of the motor vehicle. The front cover 16 and optionally also the rear cover 17 can be made of a transparent material and at least the front cover 16 can be moved into a position over or under the rear cover by means of guide rails which are connected in the front area to the side members 14 and 15.

The side members 14 and 15 are detachably connected to the A column 11 and the B column 12. FIG. 2 shows a lock mechanism for the left side member 14, which is provided in the same way, but not shown, also for the right side member 15. This lock mechanism comprises a lock tongue 18 on the front end of the side member 14 and a lock tongue 19 on the back end of the side member 14. FIG. 2 shows the lock tongue 18 in its released position pulled back into the side member 14, in which position the side member 14 is released from the A column 11. The lock tongue 19 in FIG. 2 is shown in its locked position engaged in a corresponding lock slot 20 in the B column 12, in which lock position the side member 14 is fixed on the B column 12. A front lock slot 21 which corresponds to the rear lock slot 20 is formed in the A column 11. The arrangement of the lock tongue and the lock slot can of course also be made such that there are lock slots in the side member and there are lock tongues in the A column and B column.

The lock tongues 18 and 19 are driven via a mechanism which is not shown in detail, for example, a rod mechanism or cable mechanism by an electric drive motor 22 which is, for example, integrated into the side member 14, and for example, is located in the center area between the lock tongues 18 and 19 or the ends of the side members. The electric motor drive 22 comprises a single electric motor which drives both lock tongues jointly.

Instead of a single lock tongue and a single lock slot on the respective end of the side member and the respective column, there can also be several such tongues or pins.

FIG. 1 schematically shows one embodiment of a transfer mechanism for transferring the side members 14, 15 into a stowage space 23 in the area of the rear window shelf of the motor vehicle (customarily found behind the top of the back of rear seat), this stowage space comprising, for example, a cassette (not shown) for holding the side members.

The transfer mechanism shown in FIG. 1 comprises a rod assembly with two rods per side member, of which FIG. 1 shows only the rods 24, 25 for the left side member 14. The rods 24, 25 are located laterally offset relative to one another with one end in a four-bar bearing (not shown) on the inside of the C-column 13, while their other end is connected to the rear end of the side member 14. The connection located on the side member 14 is provided at a rod 26 which is securely joined to it.

The path of motion of the rods 24, 25 and of the associated left side member 14 is shown in FIG. 1 by the dot-dash line. Accordingly, this path is a three-dimensional curve which is composed of a pivoting component between the side member 14 located between the A column and the B column 11, 12 and its position in the stowage space 23 lying roughly in a vertical plane, and a rotary component which corresponds for rotary dispacement of the side member 14 into its position between the A column and the B column 11, 12 by roughly 90° into its transversely extending position in the stowage space. The position of the left side member 14 in the stowage space is labeled 14′ and that of the right side member 15 is labeled 15′.

The stowage space positions of the side members 14′, 15′ are chosen such that the pivoting and rotational movements of the side members can take place at the same time without the side members disruptively engaging one another. Alternatively, the pivoting motion and the rotary motion of the side members 14, 15 can also take place slightly staggered in time to one another. Transferring of the side members 14′ and 15′ back into their positions between the A column 11 and the B column 12 takes place in the reverse manner. Movement of the rods 25 can be performed manually or by the action of a motorized drive.

In FIGS. 3 & 4, a second embodiment is shown, wherein the left side member 14 is linked with its rod 26 to a front lever 27 and to a rear lever 28. The front and rear levers 26, 27 form a four-bar linkage.. The rear ends of levers 27, 28 are pivotally connected to a slide 29 which comprises a front sliding element 30 and a rear sliding element 31 which are slidably movable to the rear along guide rails 32.

The guide rail 32 comprises a first track 32A for the front sliding element 30 with a larger diameter extending straight to the rear, and a second track 32B for the rear sliding element 31 with a smaller diameter extending to the rear with an end portion curved through an angle of about 90° relative to the straight first track 32A.

An actuating slide 33 is provided which is slidable relative to the slide 29 at the beginning of the movement of the side member 14 to the rear. The actuating slide 33 comprises a coulisse with a guide slot cooperating with a guide pin 35 provided on the rear lever 28. The actuating slide 33 is coupled to a drive cable 36 which is guided within a slotted channel of the guide rail 32 and which engages a pinion 38 of an electric motor drive 37 positioned in the rear of the car.

When the side member 14 is in its closed position between the A-column 11 and the B-column 12, slide 29 is locked to the guide rail 32 by means of a locking element (not shown). To start the movement of the side member 14 from its closed position to its open position in the stowage space, having released the tongue and slot mechanism as described before, slide 33 is moved rearward by means of drive cable 36 by operating the electric motor drive 37. While slide 33 travels rearward by an amount equal to the length of the slot of coulisse 34, guide pin 35 causes the rear lever 28 to swing inwardly to the position marked 28′ in the drawings. Lever 27 passively follows this movement and both the front lever 27 and the rear lever 28 cause the rod 26, and thus the side member 14, to execute a pivoting movement to the position marked by 26′. In this position, parallel to the closed position, the side member 14 can pass the C-Column 13 on its inner side and traveling movement of the side member 14 to the rear is thus enabled.

To finally enable the sliding movement of the side member 14 to the rear, as soon as guiding pin 35 has reached its position marked by 35′ at the front end of the slot of the coulisse 34, the slide 30 is brought out of engagement with the guide rail 32 and is coupled to slide 33 by a lateral movement of the locking member (not shown). By this engagement of the slides 29, 33, the slide 29 is also driven by the electric motor drive 37 by means of the drive cable 36. Sliding elements 30 and 31 travel along guide rail 32 carrying back side member 14 still parallel to its closed position. As soon as rear slide element 31 enters the curve of track 32B, while front slide element 30 follows the straight track 32A, side member 14 begins a swinging movement of about 90° to the right, thus reaching its stowage position 14″.

It is pointed out that the preferred embodiments shown and described above are not the exclusive manners in which the invention can be implemented and various modifications and alternatives will be apparent to those skilled in the art. Accordingly, the invention should not be viewed as limited to the disclosed embodiments but should be viewed broadly as encompassing everything within the scope of the appended claims.

What is claimed is:

1. Motor vehicle roof structure with a roof cover which is movably guided in an area of side members located between an A column and a B column at each side of a motor vehicle and into a position behind said columns; wherein the side members are releaseably connected to the A column and the B column; and wherein a transfer mechanism is provided for transferring the side members, after releasing thereof, into a stowage space in an area of a rear window shelf of the motor vehicle.

2. Motor vehicle roof structure as claimed in claim 1, wherein the transfer mechanism comprises a rod assembly at each side of the roof cover which is coupled in an area of a C column of the motor vehicle and is connected to an A column end of a respective one of the side members for moving the respective side member out from between the A column and the B column, for swinging the side member to the rear and for turning the side member into a transversely extending orientation for deposition in the stowage space.

3. Motor vehicle roof structure as claimed in claim 1, wherein the transfer mechanism, at each side member, comprises a guide rail which runs along the C column of the motor vehicle for sliding the released side member and a pivoting means on the rear end of the guide rail in order to pivot the side member into the transversely extending orientation for deposition in the stowage space.

4. Motor vehicle roof structure as claimed in claim 3, wherein a rear end of the guide rail is pivotally-mounted to the C column, and together with the side member with which it is associated, is swingable into the stowage space.

5. Motor vehicle roof structure as claimed in claim 1, further comprising an electric motor drive for the transfer mechanism.

6. Motor vehicle roof structure as claimed in claim 1, wherein the side members are connected by means of lock mechanisms to the A column and to the B column.

7. Motor vehicle roof structure as claimed in claim 6, wherein the lock mechanisms comprise at least one lock tongue at each end of the side member and a lock slot in a facing column surface which receives the lock tongue.

8. Motor vehicle roof structure as claimed in claim 5, wherein an electric motor actuator is provided for the lock mechanisms.

9. Motor vehicle roof structure as claimed in claim 8, wherein the actuator is located in the respective side member.

10. Motor vehicle roof structure as claimed in claim 9, wherein the actuator has a single electric motor drive for actuating the lock mechanisms on both ends of the side member.
